(19) United States
(12) Patent Application Publication
(10) Pub. No.: US 2020/0404434 A1
(43) Pub. Date: Dec. 24, 2020

(54) EAR-WORN ELECTRONIC DEVICE INCORPORATING ANTENNA MATCHING NETWORK COMPRISING A NON-FOSTER CIRCUIT

(71) Applicant: Starkey Laboratories, Inc., Eden Prairie, MN (US)

(72) Inventors: Paul Anders Shriner, Hopkins, MN (US); Ezdeen Elghannai, Eden Prairie, MN (US)

(21) Appl. No.: 16/445,933

(22) Filed: Jun. 19, 2019

(51) Int. Cl. H04R 25/00; H01Q 1/27; H04B 1/3827

(52) U.S. Cl. CPC H04R 25/554; H04R 25/65; H04B 2001/3866; H04B 1/385; H04R 2225/51; H01Q 1/273

(57) ABSTRACT

An ear-worn electronic hearing device is configured to be worn by a wearer and comprises a housing configured to be supported by, at, in or on an ear of the wearer. Electronic circuitry is disposed in the housing and comprises a radio frequency transceiver. A power source is coupled to the electronic circuitry. An antenna is disposed in, on, or extending from the housing and operably coupled to the transceiver. A matching network is operably coupled to the transceiver and the antenna. The matching network comprises a non-Foster active circuit coupled to the power source.

### TECHNICAL FIELD

This application relates generally to ear-worn electronic devices and other electronic wearable devices, including hearing devices, hearing aids, personal amplification devices, other hearables, smart watches, and fitness and/or health monitoring watches and on-body sensors.

### BACKGROUND

Hearing devices provide sound for the wearer. Some examples of hearing devices are headsets, hearing aids, speakers, cochlear implants, bone conduction devices, and personal listening devices. For example, hearing aids provide amplification to compensate for hearing loss by transmitting amplified sounds to a wearer's ear canals. Hearing devices may be capable of performing wireless communication with other devices, such as receiving streaming audio from a streaming device via a wireless link. Wireless communication may also be performed for programming the hearing device and transmitting information from the hearing device. For performing such wireless communication, hearing devices such as hearing aids can include a wireless transceiver and an antenna.

### SUMMARY

Embodiments are directed to an ear-worn electronic hearing device configured to be worn by a wearer. The hearing device comprises a housing configured to be supported by, at, in or on an ear of the wearer. Electronic circuitry is disposed in the housing and comprises a radio frequency transceiver. A power source is coupled to the electronic circuitry. An antenna is disposed in, on, or extending from the housing and operably coupled to the transceiver. A matching network is operably coupled to the transceiver and the antenna. The matching network comprises a non-Foster active circuit coupled to the power source.

Embodiments are directed to an ear-worn electronic hearing device configured to be worn by a wearer. The hearing device comprises a housing configured to be supported by, at, in or on an ear of the wearer. Electronic circuitry is disposed in the housing and comprises a radio frequency transceiver. A power source is coupled to the electronic circuitry. An antenna is disposed in, on, or extending from the housing and operably coupled to the transceiver. A matching network is operably coupled to the transceiver and the antenna. The matching network comprises a non-Foster active circuit coupled to the power source and is configured to provide a negative inductance or a negative capacitance and cause the antenna to achieve a bandwidth of at least about 80 MHz centered at about 2.44 GHz.

Embodiments are directed to a body-worn electronic device comprising a housing configured to be held by, attached to or worn by a wearer. Electronic circuitry is disposed in the housing and comprises a radio frequency transceiver. A power source is coupled to the electronic circuitry. An antenna is disposed in, on, or extending from the housing and operably coupled to the transceiver. A matching network is operably coupled to the transceiver and the antenna, the matching network comprising a non-Foster active circuit coupled to the power source.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 shows an arbitrary antenna enclosed in a sphere of radius a for purposes of describing an electrically small antenna in accordance with any of the embodiments disclosed herein;

FIG. 2 shows a traditional method for evaluating the bandwidth of an antenna for purposes of describing an electrically small antenna in accordance with any of the embodiments disclosed herein;

FIGS. 3 and 4 are graphs showing reactance versus frequency for simple series LC and parallel LC networks, respectively;

FIG. 5 is a graph showing the reactance of lossless positive and negative inductances versus frequency;

FIG. 6 is a graph showing the reactance of lossless positive and negative capacitances versus frequency;

FIGS. 7A and 7B illustrate an ear-worn electronic hearing device arrangement incorporating an antenna coupled to a matching network comprising a non-Foster circuit in accordance with any of the embodiments disclosed herein;

FIGS. 8A and 8B illustrate a custom hearing device system incorporating an antenna coupled to a matching network comprising a non-Foster circuit in accordance with any of the embodiments disclosed herein;

FIG. 9 illustrates a representative hearing device incorporating an antenna coupled to a matching network comprising a non-Foster circuit in accordance with any of the embodiments disclosed herein;

FIG. 10A is a schematic of communication circuitry which includes a matching network comprising traditional passive components, wherein the circuitry was subject to computer simulation;

FIG. 10B is a plot showing the reflection coefficient (S11 in dB) versus frequency (GHz) for the simulated communication circuitry illustrated in FIG. 10A;

FIG. 11A is a schematic of communication circuitry which includes a matching network comprising a non-Foster active component, wherein the circuitry was subject to computer simulation;

FIG. 11B is a plot showing the reflection coefficient (S11 in dB) versus frequency (GHz) for the simulated communication circuitry illustrated in FIG. 11A;

FIGS. 12A-30 illustrate representative communication circuitry which incorporates a matching network with one or more NFCs in accordance with any of the embodiments disclosed herein;

FIG. 31 shows a representative non-Foster circuit implemented as a Negative Impedance Convertor circuit in accordance with any of the embodiments disclosed herein;

FIGS. 32A and 32B show a representative non-Foster circuit implemented as a cross-coupled pair circuit in accordance with any of the embodiments disclosed herein; and

FIGS. 33-35 show representative antennas which can be coupled to a wireless communication device of an ear-worn or body-worn electronic device via a matching network comprising a non-Foster circuit in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

It is understood that the embodiments described herein may be used with any ear-worn or ear-level electronic device without departing from the scope of this disclosure. It is also understood that the embodiments described herein may be used with any body-worn electronic device without departing from the scope of this disclosure. The devices depicted in the figures are intended to demonstrate the subject matter, but not in a limited, exhaustive, or exclusive sense. Ear-worn electronic devices (also referred to herein as “hearing devices”), such as hearables (e.g., wearable earphones, ear monitors, and earbuds), hearing aids, hearing instruments, and hearing assistance devices, typically include an enclosure, such as a housing or shell, within which internal components are disposed. Typical components of a hearing device can include a processor (e.g., a digital signal processor or DSP), memory circuitry, power management circuitry, one or more communication devices (e.g., a radio, a near-field magnetic induction (NFMI) device), one or more antennas, one or more microphones, and a receiver/speaker, for example. Hearing devices can incorporate a long-range communication device, such as a Bluetooth® transceiver or other type of radio frequency (RF) transceiver. A communication device (e.g., a radio or NFMI device) of a hearing device can be configured to facilitate communication between a left ear device and a right ear device of the hearing device.

Hearing devices of the present disclosure can incorporate an antenna coupled to a high-frequency transceiver, such as a 2.4 GHz radio. The RF transceiver can conform to an IEEE 802.11 (e.g., WiFi®) or Bluetooth® (e.g., BLE, Bluetooth® 4.2, 5.0, 5.1) specification, for example. It is understood that hearing devices of the present disclosure can employ other transceivers or radios, such as a 900 MHz radio. Hearing devices of the present disclosure can be configured to receive streaming audio (e.g., digital audio data or files) from an electronic or digital source. Representative electronic/digital sources (e.g., accessory devices) include an assistive listening system, a TV streamer, a radio, a smartphone, a laptop, a cell phone/entertainment device (CPED) or other electronic device that serves as a source of digital audio data or other types of data files. Hearing devices of the present disclosure can be configured to effect bi-directional communication (e.g., wireless communication) of data with an external source, such as a remote server via the Internet or other communication infrastructure. Hearing devices that include a left ear device and a right ear device can be configured to effect bi-directional communication (e.g., wireless communication) therebetween, so as to implement ear-to-ear communication between the left and right ear devices.

The term hearing device of the present disclosure refers to a wide variety of ear-level electronic devices that can aid a person with impaired hearing. The term hearing device also refers to a wide variety of devices that can produce processed sound for persons with normal hearing. Hearing devices of the present disclosure include hearables (e.g., wearable earphones, headphones, earbuds, virtual reality headsets), hearing aids (e.g., hearing instruments), cochlear implants, and bone-conduction devices, for example. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device,” which is understood to refer to a system comprising a single left ear device, a single right ear device, or a combination of a left ear device and a right ear device.

Ear-worn electronic devices configured for wireless communication, such as hearing aids and other types of hearing devices, can be relatively small in size. Custom hearing devices, such as ITE, ITC, and CIC devices for example, are quite small in size. In the manufacture of a custom hearing device, for example, an ear impression or ear mold is taken for a particular wearer and processed to construct the housing of the hearing device. Because custom hearing devices are designed to be partially or fully inserted into a wearer's ear canal, the housing is necessarily quite small. In order to implement a functional wireless platform (e.g., @ 2.4 GHz), the antenna must be small enough to fit within such devices. The severe space limitations within the housing of an ear-worn electronic device impose a physical challenge on designing the antenna.

An antenna designed for use in an ear-worn electronic device (or a relatively small body-worn electronic device) is typically defined as a small antenna (e.g., electrically small antenna). A small antenna is one in which its maximum dimension is smaller than the radianlength, where the radianlength is defined as the wavelength divided by 2n. The performance of a small antenna has a fundamental limitation based on its physical and electrical size. As the antenna gets smaller with respect to its operating wavelength, the frequency bandwidth gets smaller and the radiation efficiency drops.

FIG. 1 shows an arbitrary antenna 100 enclosed in a sphere 102 of radius a. In this illustrative example, the antenna 100 has a center operating frequency f_{c} with a corresponding wavelength λ. This wavelength λ corresponds to a known wavenumber k, given by k=2π/λ. An antenna is considered to be electrically small if the product ka is less than 0.5. Of particular interest is the issue of how far away from f_{c} can the antenna operate before the antenna performance starts to degrade.

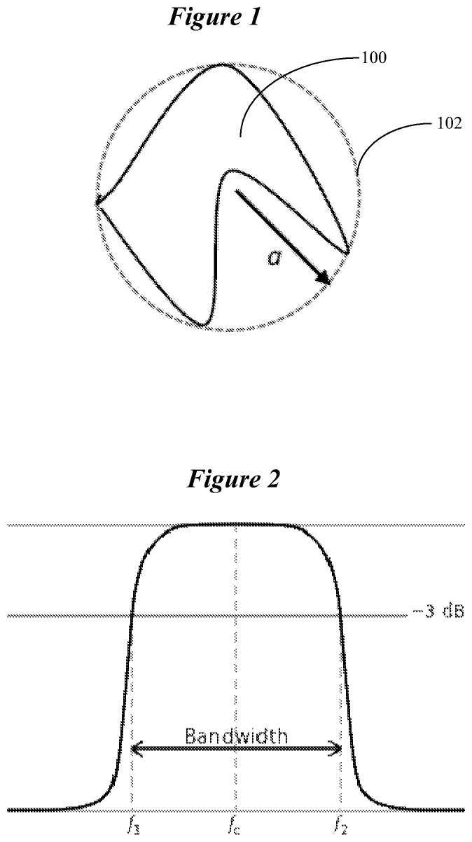

FIG. 2 shows a traditional method for defining the bandwidth of an antenna. The bandwidth is defined as the difference of f₁ and f₂, where f₁ and f₂ are respectively the lower and upper frequencies where the output (accepted or radiated power) is half or 3 dB down from f_{c}. The quality, Q, of the antenna is dependent on not only the bandwidth, but also the center operating frequency, f_{c}. This quality factor is given by

$$Q = \frac{{f}_{c}}{{f}_{2} - {f}_{1}} .$$

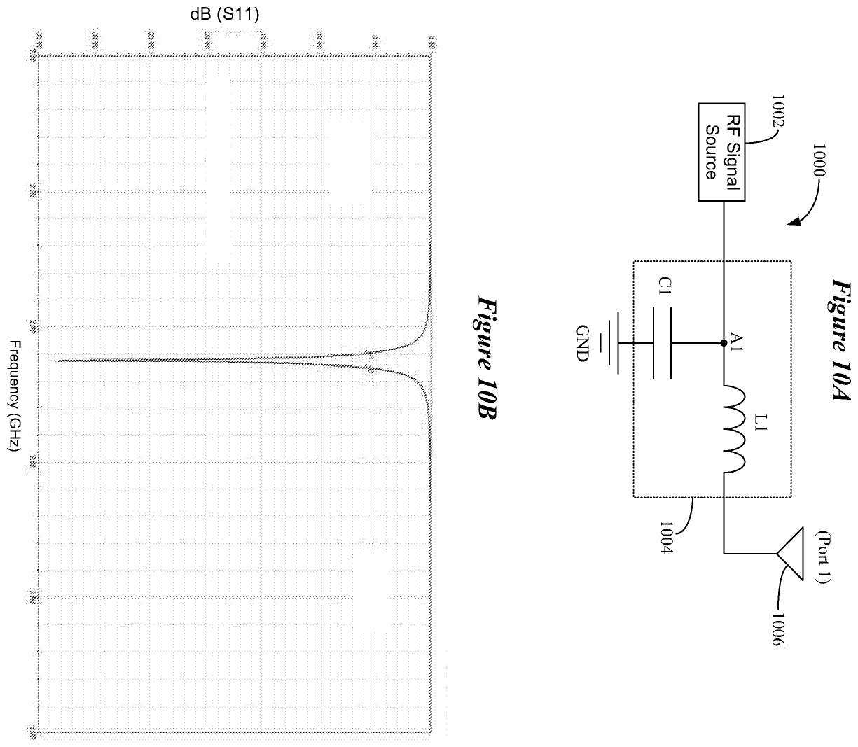

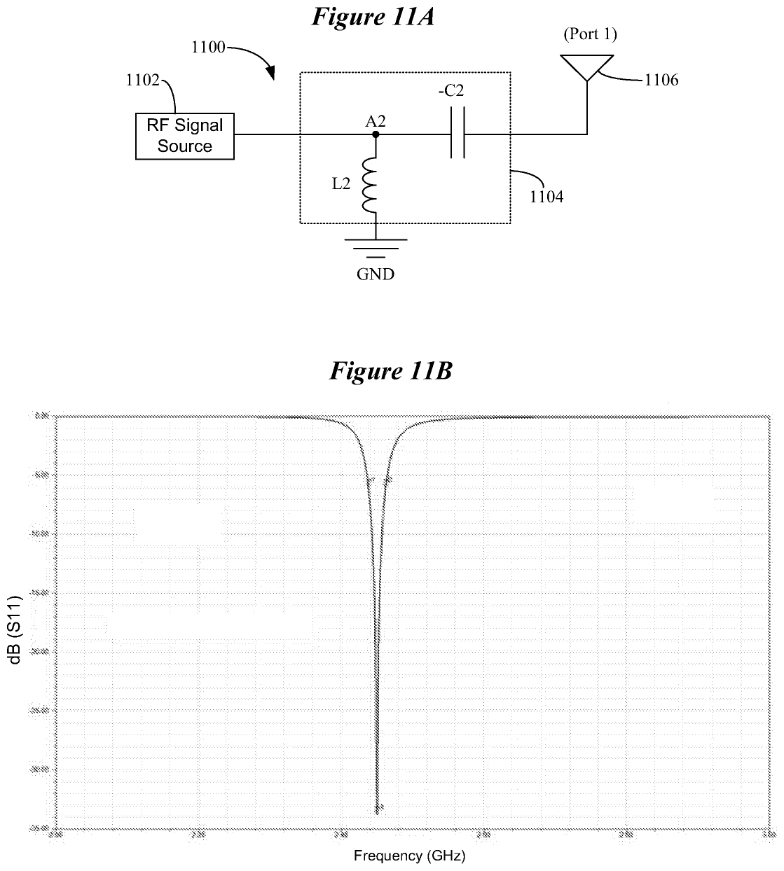

As the antenna bandwidth increases, the Q must decrease, and vice versa. Another method for defining the bandwidth of an antenna involves the use of the reflection coefficient, S11. In this second method, an S11 is chosen, 6 dB for example, and the bandwidth is defined as the frequency range for which the S11 is below this value. This second method is what is used to calculate the bandwidths shown in FIGS. 10B and 11B.

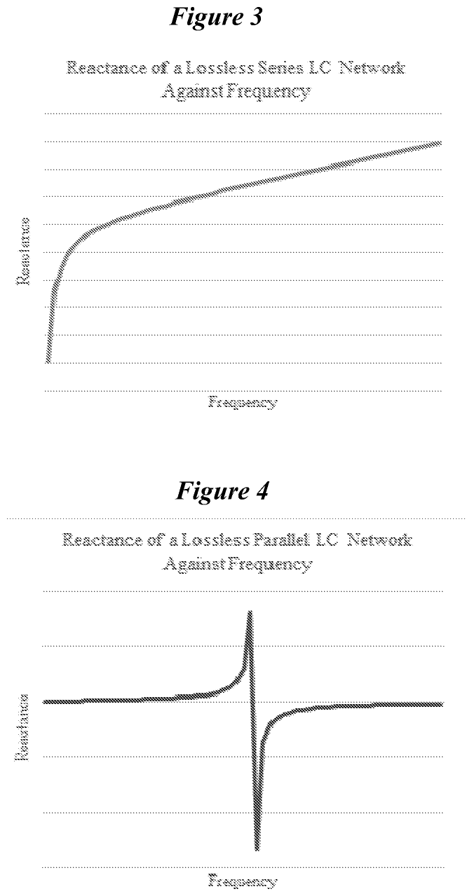

Traditional resonant circuits have a set of inductors and capacitors that are chosen to cancel out their reactances at a given frequency. Graphs of simple topologies, series LC network and parallel LC network, are shown in FIGS. 3 and 4, respectively. The reactances for these topologies are given by

$${X}_{series} = ω L - \frac{1}{ω C}$$

### (FIG. 3) and

$${X}_{parallel} = \frac{ω L}{1 - {ω}^{2} L C}$$

(FIG. 4). It is noted that inductive reactance is given by ωL and capacitive reactance is given by 1/(ωC). By implementing more elements, a wider band of frequencies can be resonated out. However, this approach is limited, as many elements would be needed to create resonance over what is typically needed for wideband applications. All passive electrically small antennas have a fundamental gain-bandwidth limitation related to their electrical size. Also, the maximum radiation power factor of such an antenna is equivalent to the inverse of the minimum quality factor of the antenna.

Embodiments of the disclosure are directed to a hearing device comprising a radio frequency (RF) transceiver, an antenna, and a matching network comprising an active non-Foster circuit (NFC) coupled to the RF transceiver and the antenna. An NFC can be configured to cause the antenna of a hearing device to operate across a wide frequency bandwidth (e.g., create a wideband resonance). An NFC is a type of active circuit that does not follow Foster's reactance theorem. This theorem states that the reactance of a passive, lossless two-terminal (one-port) network always strictly monotonically increases with frequency. In a circuit that obeys Foster's reactance theorem, the reactances of inductors and capacitors individually increase with frequency. According to Foster's reactance theorem, all lossless passive two-terminal devices must have an impedance with a reactance and susceptance that has a positive slope with frequency. An element or circuit that violates this property by having a reactance which has a negative slope with frequency is called a “non-Foster” element or circuit. As such, the term NFC used herein refers to an active circuit or element that does not obey Foster's reactance theorem.

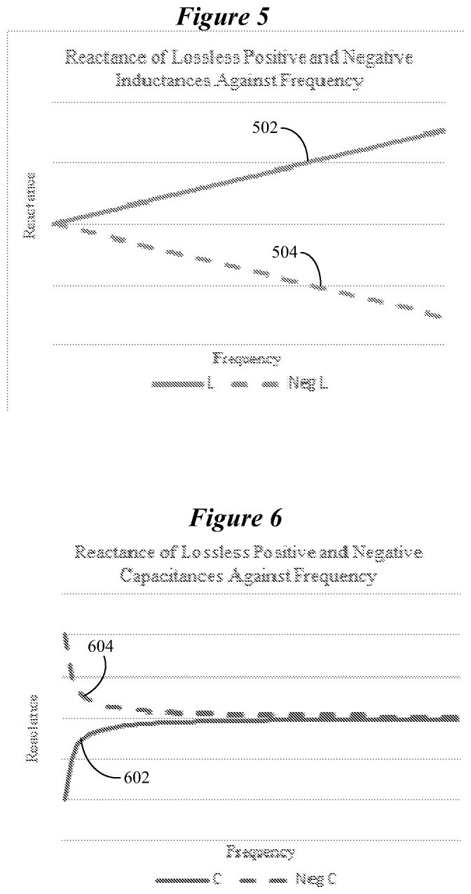

The fundamental gain-bandwidth limitation of electrically small antennas used in ear-worn and body-worn electronic devices can be overcome by loading the antenna with an active non-Foster circuit (e.g., one or more negative inductors and/or one or more negative capacitors). As is shown in FIGS. 5 and 6 (dashed lines 504, 604), active NFCs have a negative reactance vs. frequency slope. NFCs can be considered to act as a negative inductor or a negative capacitor. FIG. 5 is a graph showing the reactance of lossless positive (+L, solid line 502) and negative (−L, dashed line 504) inductances versus frequency. The reactance for a negative inductor can be characterized as X_{ind}=−ω|L|, where the inductance, L, is expressed as an absolute value for purposes of clarity. FIG. 6 is a graph showing the reactance of lossless positive (+C, solid line 602) and negative (−C, dashed line 604) capacitances versus frequency. The reactance for a negative capacitor can be characterized as

$${X}_{c a p} = \frac{1}{ω \vert C \vert} ,$$

where the capacitance, C, is expressed as an absolute value for purposes of clarity.

The graphs shown in FIGS. 5 and 6 demonstrate that non-Foster circuits can be used to cancel out a positive sloped reactance over a wide band of frequencies, as opposed to a single frequency for traditional resonators using passive inductors and capacitors. Non-Foster reactances with a negative frequency slope can be used to completely cancel equivalent Foster reactances with a positive frequency slope. As such, NFCs can be incorporated in a matching network coupled to an antenna of an ear-worn or body-worn electronic device to achieve very high bandwidths not possible using only passive inductors and capacitors. For example, an NFC incorporated in a matching network of an ear-worn or body-worn electronic device can be configured to cause the matching network and the antenna to achieve a bandwidth beyond a Bode-Fano limit.

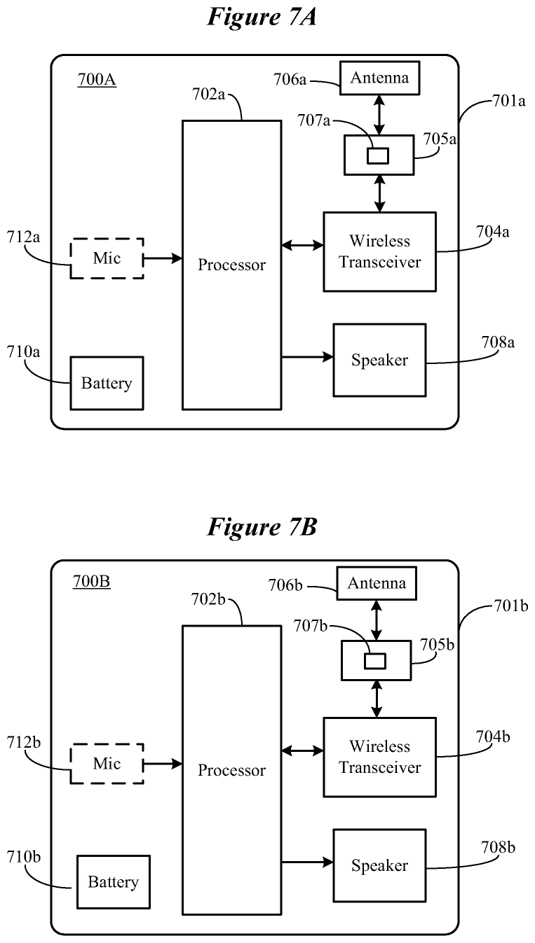

Embodiments are directed to use of an NFC in a matching network coupled to an antenna of an ear-worn or body-worn electronic device to create a wideband and efficient response, while being able to reduce the physical size of the antenna. FIGS. 7A and 7B illustrate various components of a representative hearing device arrangement in accordance with any of the embodiments disclosed herein. FIGS. 7A and 7B illustrate first and second hearing devices 700A and 700B configured to be supported at, by, in or on left and right ears of a wearer. In some embodiments, a single hearing device 700A or 700B can be supported at, by, in or on the left ear or the right ear of a wearer. As illustrated, the first and second hearing devices 700A and 700B include the same functional components. It is understood that the first and second hearing devices 700A and 700B can include different functional components. The first and second hearing devices 700A and 700B can be representative of any of the hearing devices disclosed herein.

The first and second hearing devices 700A and 700B include an enclosure 701a, 701b configured for placement, for example, over or on the ear, entirely or partially within the external ear canal (e.g., between the pinna and ear drum) or behind the ear. Disposed within the enclosure 701a, 701b is a processor 702a, 702b which incorporates or is coupled to memory circuitry. The processor 702a, 702b can include or be implemented as a multi-core processor, a digital signal processor (DSP), an audio processor or a combination of these processors. For example, the processor 702a, 702b may be implemented in a variety of different ways, such as with a mixture of discrete analog and digital components that include a processor configured to execute programmed instructions contained in a processor-readable storage medium (e.g., solid-state memory, e.g., Flash).

The processor 702a, 702b is coupled to a wireless transceiver 704a, 704b (also referred to herein as a radio), such as a BLE transceiver. The wireless transceiver 704a, 704b is operably coupled to an antenna 706a, 706b configured for transmitting and receiving radio signals. In this and other embodiments, the antenna 706a, 706b can be situated within the enclosure 701a, 701b (e.g., partially or entirely), on the enclosure 701a, 701b (e.g., partially or entirely on an exterior enclosure surface), or extend from the enclosure 701a, 701b (e.g., via a pull-cord or pull-cord loop). The antenna 706a, 706b is coupled to a matching network 705a, 705b which includes an NFC 707a, 707b (or multiple NFCs 707a, 707b). The NFC 707a, 707b is an embedded element within or otherwise connected to the antenna 706. The matching network 705a, 705b incorporating the NFC 707a, 707b is coupled to the antenna 706a, 706b and the wireless transceiver 704a, 704b.

The wireless transceiver 704a, 704b, matching network 705a, 705b, and antenna 706a, 706b can be configured to enable ear-to-ear communication between the two hearing devices 700A and 700B, as well as communications with an external device (e.g., a smartphone or a digital music player). A battery 710a, 710b or other power source (rechargeable or conventional) is provided within the enclosure 701a, 701b and is configured to provide power to the various components of the hearing devices 700A and 700B, including the active NFC 707a, 707b. A speaker or receiver 708a, 708b is coupled to an amplifier (not shown) and the processor 702a, 702b. The speaker or receiver 708a, 708b is configured to generate sound which is communicated to the wearer's ear.

In some embodiments, the hearing devices 700A and 700B include a microphone 712a, 712b mounted on or inside the enclosure 701a, 701b. The microphone 712a, 712b may be a single microphone or multiple microphones, such as a microphone array. The microphone 712a, 712b can be coupled to a preamplifier (not shown), the output of which is coupled to the processor 702a, 702b. The microphone 712a, 712b receives sound waves from the environment and converts the sound into an input signal. The input signal is amplified by the preamplifier and sampled and digitized by an analog-to-digital converter of the processor 702a, 702b, resulting in a digitized input signal. In some embodiments (e.g., hearing aids), the processor 702a, 702b (e.g., DSP circuitry) is configured to process the digitized input signal into an output signal in a manner that compensates for the wearer's hearing loss. When receiving an audio signal from an external source, the wireless transceiver 704a, 704b may produce a second input signal for the DSP circuitry of the processor 702a, 702b that may be combined with the input signal produced by the microphone 712a, 712b or used in place thereof. In other embodiments, (e.g., hearables), the processor 702a, 702b can be configured to process the digitized input signal into an output signal in a manner that is tailored or optimized for the wearer (e.g., based on wearer preferences). The output signal is then passed to an audio output stage that drives the speaker or receiver 708a, 708b, which converts the output signal into an audio output.

Some embodiments are directed to a custom hearing aid, such as an ITC, CIC, or IIC hearing aid. For example, some embodiments are directed to a custom hearing aid which includes a wireless transceiver 704a, 704b, a matching network 705a, 705b incorporating an NFC 707a, 707b, and an antenna 706a, 706b configured to operate in the 2.4 GHz ISM frequency band or other applicable communication band (referred to as the “Bluetooth® band” herein). As was discussed previously, creating a robust antenna arrangement for a 2.4 GHz custom hearing aid represents a significant engineering challenge. A custom hearing aid is severely limited in space, and the antenna arrangement is in close proximity to other electrical components, both of which impact antenna performance. Because the human body is very lossy and a custom hearing aid is positioned within the ear canal, a high performance antenna 706a, 706b (e.g., high antenna radiation efficiency and/or wide bandwidth) is particularly desirable. Embodiments of the disclosure are directed to a high performance wireless communication arrangement comprising an antenna 706a, 706b coupled to a wireless transceiver 704a, 704b via a matching network 705a, 705b which incorporates an NFC 707a, 707b.

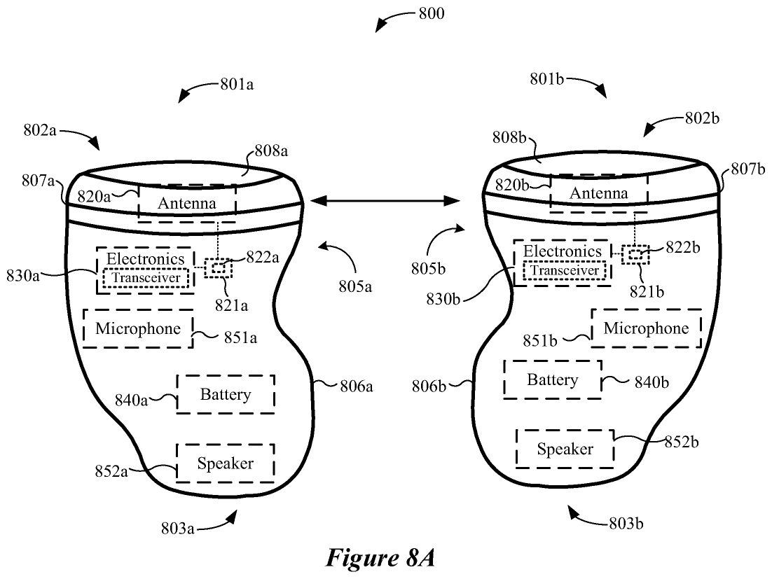

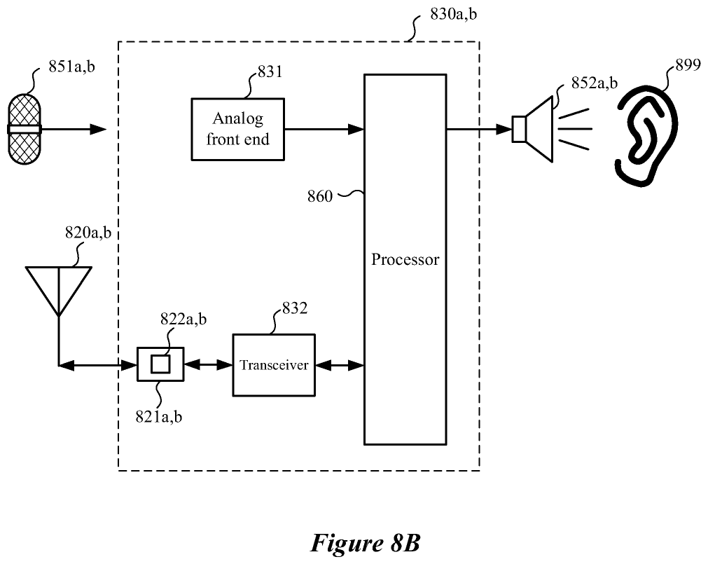

FIGS. 8A and 8B illustrate a custom hearing aid system which incorporates a high performance antenna arrangement including a matching network comprising an NFC in accordance with any of the embodiments disclosed herein. The hearing aid system 800 shown in FIGS. 8A and 8B includes two hearing devices, e.g., left 801a and right 801b side hearing devices, configured to wirelessly communicate with each other and external devices and systems. FIG. 8A conceptually illustrates functional blocks of the hearing devices 801a, 801b. The position of the functional blocks in FIG. 8A does not necessarily indicate actual locations of components that implement these functional blocks within the hearing devices 801a, 801b. FIG. 8B is a block diagram of components that may be disposed at least partially within the enclosure 805a, 805b of the hearing device 801a, 801b.

Each hearing device 801a, 801b includes a physical enclosure 805a, 805b that encloses an internal volume. The enclosure 805a, 805b is configured for at least partial insertion within the wearer's ear canal. The enclosure 805a, 805b includes an external side 802a, 802b that faces away from the wearer and an internal side 803a, 803b that is inserted in the ear canal. The enclosure 805a, 805b comprises a shell 806a, 806b and a faceplate 807a, 807b. The shell 806a, 806b typically has a shape that is customized to the shape of a particular wearer's ear canal. In some configurations, the shell 806a, 806b is fashioned from semi-soft material (e.g., semi-soft polymer) which, when inserted, that takes on the shape of the particular wearer's ear canal.

The faceplate 807a, 807b may include a battery door 808a, 808b or drawer disposed near the external side 802a, 802b of the enclosure 805a, 805b and configured to allow the battery 840a, 840b to be inserted and removed from the enclosure 805a, 805b (noting that the battery 840a, 840 is typically positioned nearer to the faceplate 807a, 807b than illustrated). An antenna 820a, 820b is coupled to a wireless transceiver (XCVR) of the electronic circuitry 830a, 830b via a matching network 821a, 821b. The matching network 821a, 821b includes an NFC 822a, 822b, various configurations of which are illustrated and described herein. The NFC 822a, 822b is an active circuit which draws power from the battery 840a, 840b. The antenna 820a, 820b can be mounted on the faceplate 807a, 807b or another structure of the shell 806a, 806b.

The battery 840a, 840b powers electronic circuitry 830a, 830b which is also disposed within the shell 806a, 806b. As illustrated in FIGS. 8A and 8B, the hearing device 801a, 801b may include one or more microphones 851a, 851b configured to pick up acoustic signals and to transduce the acoustic signals into microphone electrical signals. The electrical signals generated by the microphones 851a, 851b may be conditioned by an analog front end 831 (see FIG. 8B) by filtering, amplifying and/or converting the microphone electrical signals from analog to digital signals so that the digital signals can be further processed and/or analyzed by the processor 860. The processor 860 may perform signal processing and/or control various tasks of the hearing device 801a, 801b. In some implementations, the processor 860 comprises a DSP that may include additional computational processing units operating in a multi-core architecture.

The processor 860 is configured to control wireless communication between the hearing devices 801a, 801b and/or an external accessory device (e.g., a smartphone, a digital music player) via the antenna 820a, 820b, the wireless transceiver 832, and the matching network 821a, 821b which incorporates the NFC 822a, 822b. The wireless communication may include, for example, audio streaming, data, and/or control signals. The transceiver 832 has a receiver portion that receives communication signals from the antenna 820a, 820b and matching network 821a, 821b, demodulates the communication signals, and transfers the signals to the processor 860 for further processing. The transceiver 832 also includes a transmitter portion that modulates output signals from the processor 860 for transmission via the matching network 821a, 821b and the antenna 820a, 820b. Electrical signals from the microphone 851a, 851b and/or wireless communication received via the antenna 820a, 820b and matching network 821a, 821b may be processed by the processor 860 and converted to acoustic signals played to the wearer's ear 899 via a speaker 852a, 852b.

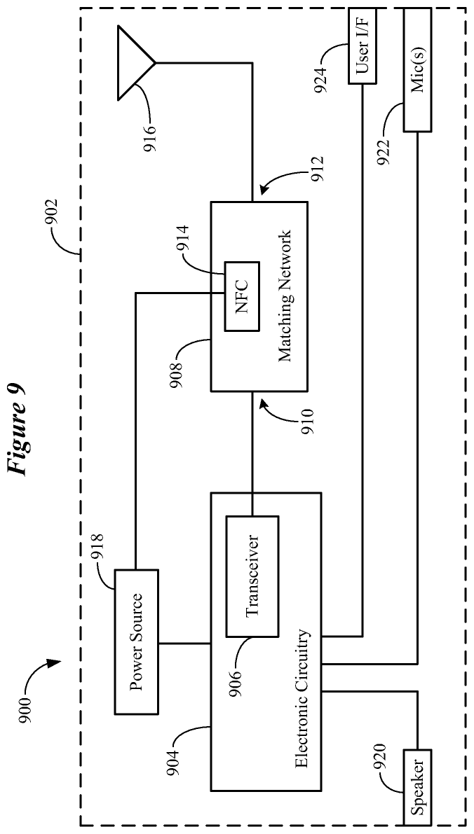

FIG. 9 illustrates a representative hearing device incorporating an antenna coupled to a matching network comprising a non-Foster circuit in accordance with any of the embodiments disclosed herein. The hearing device 900 shown in FIG. 9 includes a housing 902 configured to be supported by, at, in or on an ear of a wearer. Electronic circuitry 904 is disposed in the housing 902 and comprises, among other components, a radio frequency transceiver 906. A power source 918 is disposed in the housing 902 and coupled to the electronic circuitry 904. An antenna 916 is disposed in, on, or extending from the housing 902. The antenna 916 is operably coupled to the transceiver 906. A matching network 908 is operably coupled to the transceiver 906 and the antenna 916. The matching network 908 includes an input 910 coupled to the transceiver 906 and an output 912 coupled to the antenna 916. It is understood that the terms input and output with regard to the matching network 908 are used for convenience, inasmuch as the input and output will change depending on whether the transceiver 906 is in a transmit mode or a receive mode.

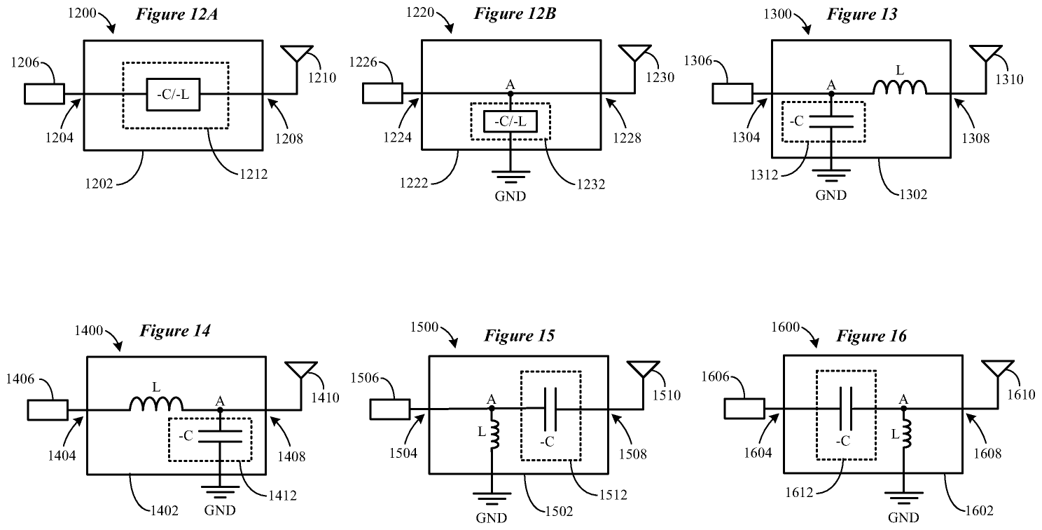

The matching network 908 includes at least one active NFC 914 coupled to the power source 918 and between the transceiver 906 and the antenna 916. It is understood that the matching network 908 can also include at least one passive component (e.g., Foster component). The NFC 914 is configured to provide a negative reactance that offsets a reactance of the antenna 916. For example, the NFC 914 can be configured to provide a negative inductance or a negative capacitance. The NFC 914 is preferably configured to cause the matching network 908 and the antenna 916 to achieve a bandwidth beyond the Bodi-Fano limit. According to some embodiments, the NFC 914 and the matching network 908 are configured to cause the antenna 916 to achieve a bandwidth of at least 80 MHz (e.g., a bandwidth of at least 80 MHz centered at about 2.44 GHz). In some configurations, the NFC 914 comprises at least one negative inductor and at least one capacitor. In other configurations, the NFC 914 comprises at least one negative capacitor and at least one inductor. In further configurations, the NFC 916 comprises at least one negative inductor and at least one negative capacitor. Various configurations of the NFC 914 are contemplated, including those illustrated in FIGS. 12A-30 discussed hereinbelow.

Simulations were performed to evaluate the performance of communication circuitry suitable for incorporation in an ear-worn or a body-worn electronic device comprising an RF signal source, a matching network including a non-Foster active component, and an antenna. Communication circuitry which included a traditional passive matching network (See FIG. 10A) was compared against communication circuitry which included a matching network with a non-Foster active component (see FIG. 10B).

The communication circuitry 1000 shown in FIG. 10A includes an RF signal source 1002 coupled to an antenna 1006 (Port 1) via a passive matching network 1004. The matching network 1004 includes an inductor L1 in series with the RF signal source 1002 and the antenna 1006, and a shunt capacitor C1 coupled between connection A1 and ground (GND). The value of inductor L1 was set to 5.89 nH, and the value of capacitor C1 was set to 4.47 pF. The matching network 1004 was designed to be matched at 2.45 GHz.

The communication circuitry 1100 shown in FIG. 11A includes an RF signal source 1102 coupled to an antenna 1106 (Port 1) via a matching network 1104 comprising a non-Foster active component. The matching network 1104 includes an NFC in the form of a negative capacitor C2 (shown as −C2) in series with the RF signal source 1102 and the antenna 1106. A shunt inductor L2 is coupled between connection A2 and ground (GND). The value of C2 was set to −1.017 pF, and the value of inductor L2 was set to 0.945 nH. The matching network 1104 was designed to be matched at 2.45 GHz.

FIGS. 10B and 11B are plots showing the reflection coefficient (S11 in dB) versus frequency (GHz) for the simulated communication circuitry 1000 and 1100, respectively. The network 1004 providing a passive match had a 6 dB bandwidth of 20.8 MHz. The network 1104 providing a non-Foster match had a 6 dB bandwidth of 24.3 MHz, which represented an increase of ˜17% in the bandwidth when compared to the passive match.

FIGS. 12A-30 illustrate representative communication circuitry which incorporates a matching network with one or more NFCs in accordance with any of the embodiments disclosed herein. The representative communication circuitry shown in FIGS. 12A-30 can be incorporated in any ear-worn or body-worn electronic device, including those disclosed herein.

FIG. 12A illustrates communication circuitry 1200 which includes a wireless transceiver 1206 coupled to an antenna 1210 via a matching network 1202. The matching network 1202 includes an input 1204 coupled to the transceiver 1206 and an output 1208 coupled to the antenna 1210. The matching network 1202 includes an NFC 1212 configured as a negative capacitor (−C) or a negative inductor (−L) in series with the transceiver 1206 and the antenna 1210.

FIG. 12B illustrates communication circuitry 1220 which includes a wireless transceiver 1226 coupled to an antenna 1230 via a matching network 1222. The matching network 1222 includes an input 1224 coupled to the transceiver 1226 and an output 1228 coupled to the antenna 1230. The matching network 1222 includes an NFC 1232 configured as a negative capacitor (−C) or a negative inductor (−L) coupled in shunt between connection A and ground (GND).

FIG. 13 illustrates communication circuitry 1300 which includes a wireless transceiver 1306 coupled to an antenna 1310 via a matching network 1302. The matching network 1302 includes an input 1304 coupled to the transceiver 1306 and an output 1308 coupled to the antenna 1310. The matching network 1302 includes an inductor L in series with the transceiver 1306 and the antenna 1310. The matching network 1302 also includes an NFC 1312 configured as a negative capacitor −C coupled in shunt between connection A and ground (GND). In FIG. 13, connection A is between the input 1304 of the matching network 1302 and the inductor L.

FIG. 14 illustrates communication circuitry 1400 which includes a wireless transceiver 1406 coupled to an antenna 1410 via a matching network 1402. The matching network 1402 includes an input 1404 coupled to the transceiver 1406 and an output 1408 coupled to the antenna 1410. The matching network 1402 includes an inductor L in series with the transceiver 1406 and the antenna 1410. The matching network 1402 also includes an NFC 1412 configured as a negative capacitor −C coupled in shunt between connection A and ground (GND). In FIG. 14, connection A is between the inductor L and the output 1408 of the matching network 1402.

FIG. 15 illustrates communication circuitry 1500 which includes a wireless transceiver 1506 coupled to an antenna 1510 via a matching network 1502. The matching network 1502 includes an input 1504 coupled to the transceiver 1506 and an output 1508 coupled to the antenna 1510. The matching network 1502 includes an NFC 1512 configured as a negative capacitor −C coupled in series with the transceiver 1506 and the antenna 1510. The matching network 1502 also includes an inductor L coupled in shunt between connection A and ground (GND). In FIG. 15, connection A is between the input 1504 of the matching network 1502 and the NFC 1512.

FIG. 16 illustrates communication circuitry 1600 which includes a wireless transceiver 1606 coupled to an antenna 1610 via a matching network 1602. The matching network 1602 includes an input 1604 coupled to the transceiver 1606 and an output 1608 coupled to the antenna 1610. The matching network 1602 includes an NFC 1612 configured as a negative capacitor −C coupled in series with the transceiver 1606 and the antenna 1610. The matching network 1602 also includes an inductor L coupled in shunt between connection A and ground (GND). In FIG. 16, connection A is between the output 1608 of the matching network 1602 and the NFC 1612.

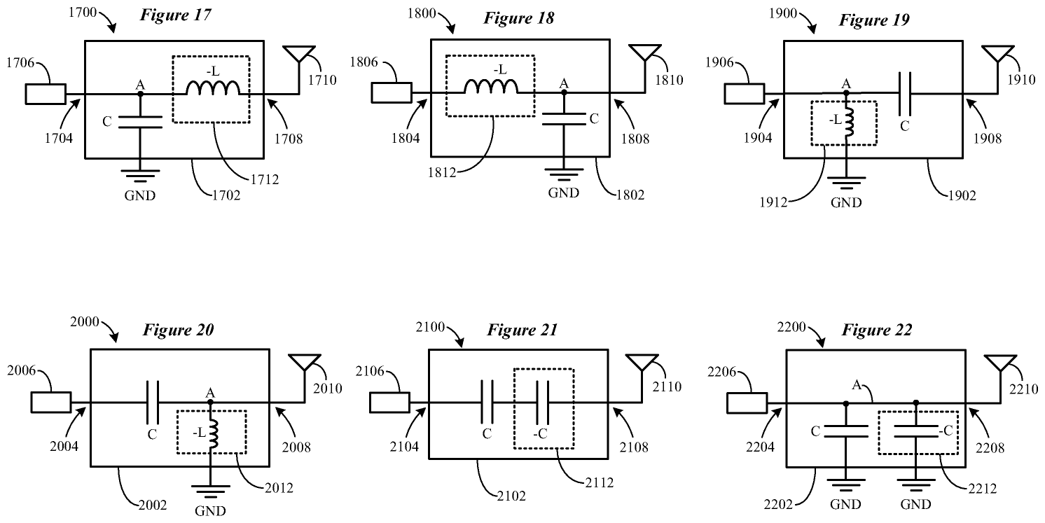

FIG. 17 illustrates communication circuitry 1700 which includes a wireless transceiver 1706 coupled to an antenna 1710 via a matching network 1702. The matching network 1702 includes an input 1704 coupled to the transceiver 1706 and an output 1708 coupled to the antenna 1710. The matching network 1702 includes an NFC 1712 configured as a negative inductor −L coupled in series with the transceiver 1706 and the antenna 1710. The matching network 1702 also includes a capacitor C coupled in shunt between connection A and ground (GND). In FIG. 17, connection A is between the input 1704 of the matching network 1702 and the NFC 1712.

FIG. 18 illustrates communication circuitry 1800 which includes a wireless transceiver 1806 coupled to an antenna 1810 via a matching network 1802. The matching network 1802 includes an input 1804 coupled to the transceiver 1806 and an output 1808 coupled to the antenna 1810. The matching network 1802 includes an NFC 1812 configured as a negative inductor −L coupled in series with the transceiver 1806 and the antenna 1810. The matching network 1802 also includes a capacitor C coupled in shunt between connection A and ground (GND). In FIG. 18, connection A is between the output 1808 of the matching network 1802 and the NFC 1812.

FIG. 19 illustrates communication circuitry 1900 which includes a wireless transceiver 1906 coupled to an antenna 1910 via a matching network 1902. The matching network 1902 includes an input 1904 coupled to the transceiver 1906 and an output 1908 coupled to the antenna 1910. The matching network 1902 includes a capacitor C in series with the transceiver 1906 and the antenna 1910. The matching network 1902 also includes an NFC 1912 configured as a negative inductor −L coupled in shunt between connection A and ground (GND). In FIG. 19, connection A is between the input 1904 of the matching network 1902 and the capacitor C.

FIG. 20 illustrates communication circuitry 2000 which includes a wireless transceiver 2006 coupled to an antenna 2010 via a matching network 2002. The matching network 2002 includes an input 2004 coupled to the transceiver 2006 and an output 2008 coupled to the antenna 2010. The matching network 2002 includes a capacitor C in series with the transceiver 2006 and the antenna 2010. The matching network 2002 also includes an NFC 2012 configured as a negative inductor −L coupled in shunt between connection A and ground (GND). In FIG. 20, connection A is between the output 2008 of the matching network 2002 and the capacitor C.

FIG. 21 illustrates communication circuitry 2100 which includes a wireless transceiver 2106 coupled to an antenna 2110 via a matching network 2102. The matching network 2102 includes an input 2104 coupled to the transceiver 2106 and an output 2108 coupled to the antenna 2110. The matching network 2102 includes a capacitor C and an NFC 2112 coupled in series with the transceiver 2106 and the antenna 2110. The NFC 2112 is configured as a negative capacitor −C. It is noted that the capacitor C and the negative capacitor −C can be positioned in any order.

FIG. 22 illustrates communication circuitry 2200 which includes a wireless transceiver 2206 coupled to an antenna 2210 via a matching network 2202. The matching network 2202 includes an input 2204 coupled to the transceiver 2206 and an output 2208 coupled to the antenna 2210. The matching network 2202 includes a capacitor C and an NFC 2212 each coupled in shunt between connection A and ground (GND). The NFC 2212 is configured as a negative capacitor −C. It is noted that the capacitor C and the negative capacitor −C can be positioned in any order.

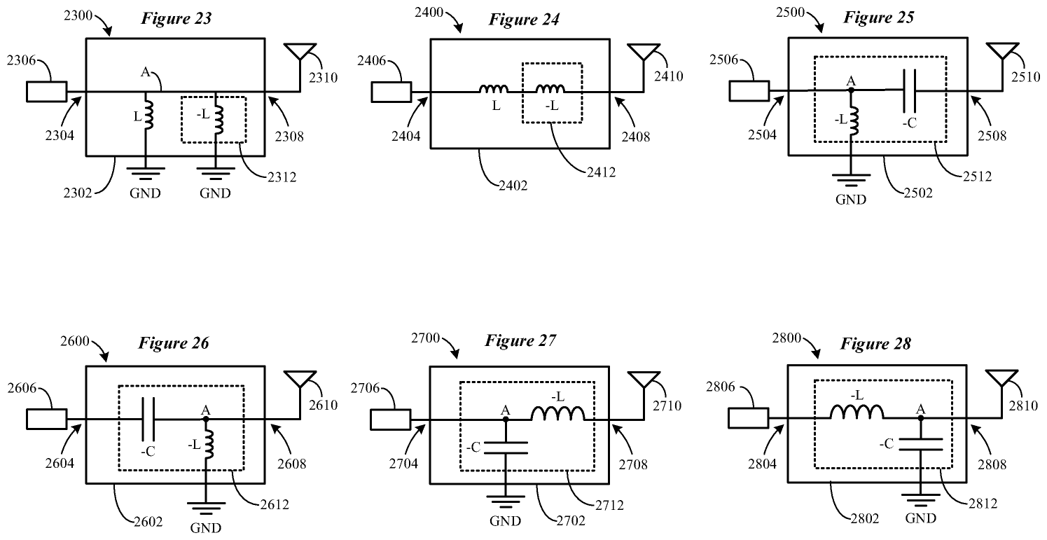

FIG. 23 illustrates communication circuitry 2300 which includes a wireless transceiver 2306 coupled to an antenna 2310 via a matching network 2302. The matching network 2302 includes an input 2304 coupled to the transceiver 2306 and an output 2308 coupled to the antenna 2310. The matching network 2302 includes an inductor L and an NFC 2312 each coupled in shunt between connection A and ground (GND). The NFC 2312 is configured as a negative inductor −L. It is noted that the inductor L and the negative inductor −L can be positioned in any order.

FIG. 24 illustrates communication circuitry 2400 which includes a wireless transceiver 2406 coupled to an antenna 2410 via a matching network 2402. The matching network 2402 includes an input 2404 coupled to the transceiver 2406 and an output 2408 coupled to the antenna 2410. The matching network 2402 includes an inductor L and an NFC 2412 coupled in series with the transceiver 2406 and the antenna 2410. The NFC 2412 is configured as a negative inductor −L. It is noted that the inductor L and the negative inductor −L can be positioned in any order.

FIG. 25 illustrates communication circuitry 2500 which includes a wireless transceiver 2506 coupled to an antenna 2510 via a matching network 2502. The matching network 2502 includes an input 2504 coupled to the transceiver 2506 and an output 2508 coupled to the antenna 2510. The matching network 2502 includes an NFC 2512 configured to include a negative capacitor −C coupled in series with the transceiver 2506 and the antenna 2510. The NFC 2512 is also configured to include a negative inductor −L coupled in shunt between connection A and ground (GND). In FIG. 25, connection A is between the input 2504 of the matching network 2502 and the negative capacitor −C.

FIG. 26 illustrates communication circuitry 2600 which includes a wireless transceiver 2606 coupled to an antenna 2610 via a matching network 2602. The matching network 2602 includes an input 2604 coupled to the transceiver 2606 and an output 2608 coupled to the antenna 2610. The matching network 2602 includes an NFC 2612 configured to include a negative capacitor −C coupled in series with the transceiver 2606 and the antenna 2610. The NFC 2612 is also configured to include a negative inductor −L coupled in shunt between connection A and ground (GND). In FIG. 26, connection A is between the output 2608 of the matching network 2602 and the negative capacitor −C.

FIG. 27 illustrates communication circuitry 2700 which includes a wireless transceiver 2706 coupled to an antenna 2710 via a matching network 2702. The matching network 2702 includes an input 2704 coupled to the transceiver 2706 and an output 2708 coupled to the antenna 2710. The matching network 2702 includes an NFC 2712 configured to include a negative inductor −L coupled in series with the transceiver 2706 and the antenna 2710. The NFC 2712 is also configured to include a negative capacitor −C coupled in shunt between connection A and ground (GND). In FIG. 27, connection A is between the input 2704 of the matching network 2702 and the negative inductor −L.

FIG. 28 illustrates communication circuitry 2800 which includes a wireless transceiver 2806 coupled to an antenna 2810 via a matching network 2802. The matching network 2802 includes an input 2804 coupled to the transceiver 2806 and an output 2808 coupled to the antenna 2810. The matching network 2802 includes an NFC 2812 configured to include a negative inductor −L coupled in series with the transceiver 2806 and the antenna 2810. The NFC 2812 is also configured to include a negative capacitor −C coupled in shunt between connection A and ground (GND). In FIG. 28, connection A is between the output 2808 of the matching network 2802 and the negative inductor −L.

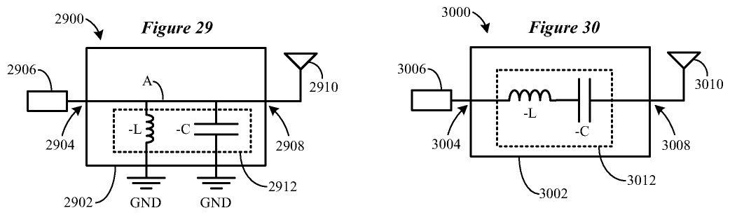

FIG. 29 illustrates communication circuitry 2900 which includes a wireless transceiver 2906 coupled to an antenna 2910 via a matching network 2902. The matching network 2902 includes an input 2904 coupled to the transceiver 2906 and an output 2908 coupled to the antenna 2910. The matching network 2902 includes an NFC 2912 configured to include a negative inductor −L and a negative capacitor −C each coupled in shunt between connection A and ground (GND). It is noted that the negative inductor −L and the negative capacitor −C can be positioned in any order.

FIG. 30 illustrates communication circuitry 3000 which includes a wireless transceiver 3006 coupled to an antenna 3010 via a matching network 3002. The matching network 3002 includes an input 3004 coupled to the transceiver 3006 and an output 3008 coupled to the antenna 3010. The matching network 3002 includes an NFC 3012 configured to include a negative inductor −L and a negative capacitor −C coupled in series with the transceiver 3006 and the antenna 3010. It is noted that the negative inductor −L and the negative capacitor −C can be positioned in any order.

As was previously discussed, FIGS. 12A-30 illustrate representative matching networks with one or more NFCs in accordance with any of the embodiments disclosed herein. It is understood that any of the circuit configurations shown in FIGS. 12A-30 can be used for balanced inputs and outputs, as well as unbalanced inputs and outputs. It is also understood that any of the circuit configurations shown in FIGS. 12A-30 can be combined to form a matching network.

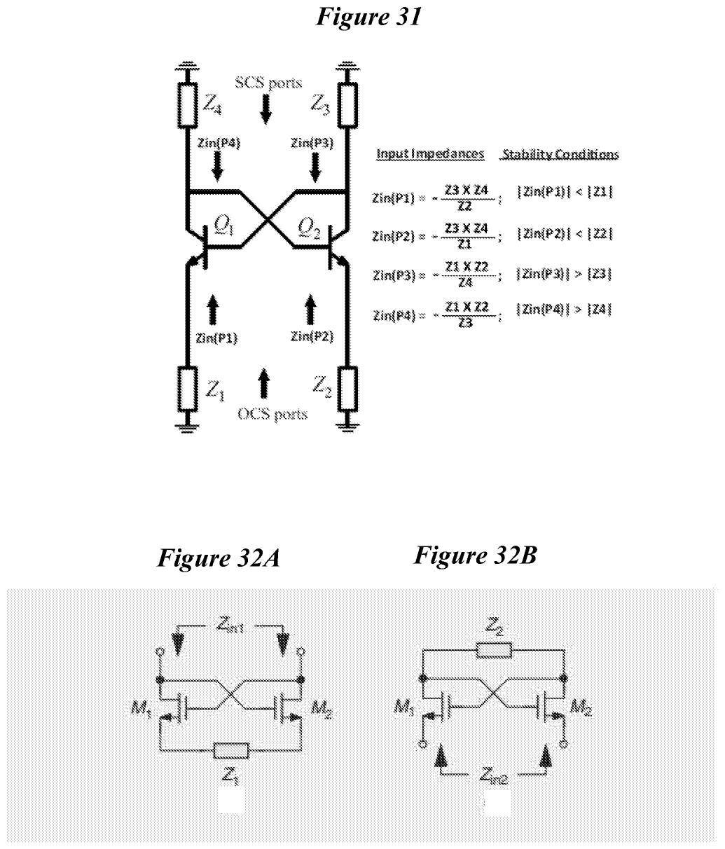

The NFCs described hereinabove can be implemented using a variety of circuit topologies. In general, active circuits that generate non-Foster impedances work on the basic principle of inverting the current through a load while maintaining the voltage across it, or inverting the voltage across a load while maintaining the current through it, leading to a negated load impedance. According to various implementations, an NFC of a type described herein can be implemented as a Negative Impedance Convertor (NIC) circuit, an example of which is shown in FIG. 31. FIG. 31 shows the circuitry topology of a representative NIC circuit with associated input impedance and stability conditions. The NIC circuit shown in FIG. 31 can be configured either as a one-port network (unbalanced) to be used as a shunt element, or as a two-port network (balanced) to be used as a floating series element.

The NIC circuit shown in FIG. 31 employs a cross-coupled transistor topology to negate an attached RLC network, and has a positive feedback network. The positive feedback network can lead to instability unless the NIC circuit is properly loaded with the required impedances to ensure stability. There are two basic conditions for stability: (1) If the input to the NIC circuit is at the emitter of the transistor, the NIC circuit will be open circuit stable (OCS) by ensuring that the NIC circuit sees an open circuit at its input; (2) If the input to the NIC circuit is at the base-collector junction, the NIC circuit will be short circuit stable (SCS) by ensuring that the NIC circuit sees a short circuit at its input. It is noted that these are the extreme conditions. Stability can usually be achieved by connecting a load with a larger impedance magnitude than that of the input impedance at the OCS ports, and by connecting a load with a smaller impedance magnitude than that of the input impedance at the SCS ports. It is noted that care should be taken to ensure that the impedance conditions are satisfied throughout the bandwidth of operation of the NIC circuit. According to other implementations, an NFC of the type described herein can be implemented as a cross-coupled pair circuit, an example of which is shown in FIGS. 32A and 32B. Because of its internal positive feedback, the cross-coupled pair NFC shown in FIGS. 32A and 32B operates as an impedance negator. The cross-coupled pair produces an impedance of Zᵢₙ₁=−Z₁−2/gₘ between the drains or Z=−Z₂+2/gₘ between the sources, assuming that gₘ is the transconductance of each transistor (M₁ and M₂ have the same gₘ). If Z₁ is a capacitor, for example, Zᵢₙ₁ contains a negative capacitance, allowing the cancellation of positive capacitance at the drains. Similarly, if Z₁ is an inductor, for example, Zᵢₙ₁ contains a negative inductance, allowing the cancellation of positive inductance at the drains.

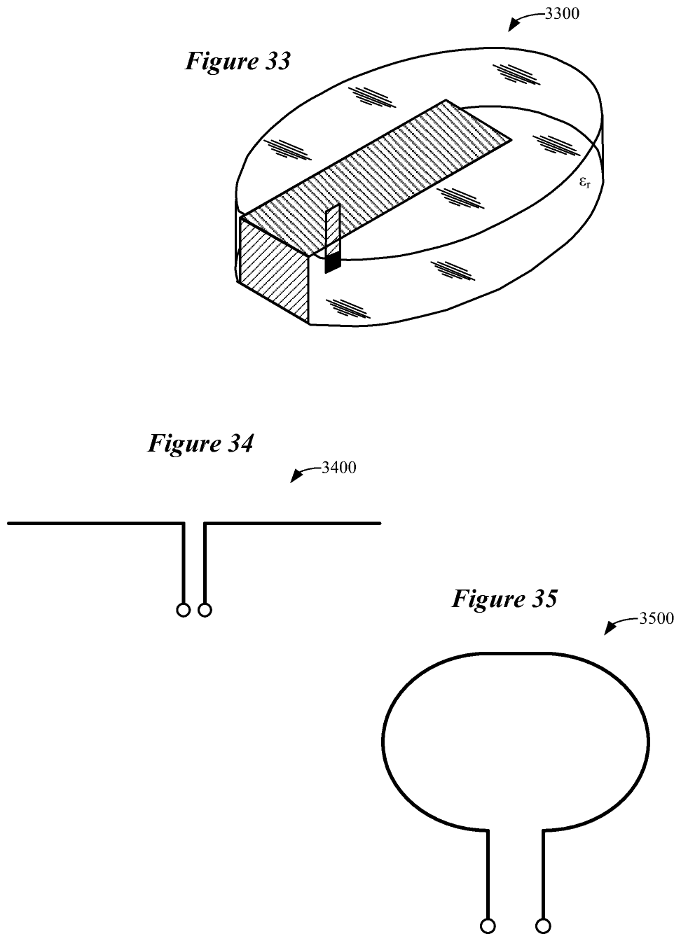

An ear-worn or body-worn electronic device of the present disclosure can incorporate any type of antenna configured to operate within a desired frequency band, such as a Bluetooth® band. FIGS. 33-35 illustrate non-limiting representative antennas that can be incorporated in an ear-worn or body-worn electronic device which includes a wireless transceiver and a matching network comprising one or more NFCs. FIG. 33 shows a particular type of patch antenna referred to as a Planar Inverted-F Antenna (PIFA) 3300. Patch antennas, including PIFAs and Inverted-F Antennas (IFAs), also referred to as rectangular microstrip antennas, are low profile and lightweight making them suitable for use in ear-worn and body-worn electronic devices. FIG. 34 shows a representative dipole antenna 3400, which can be a meandered dipole antenna. FIG. 35 shows a loop antenna 3500. Although shown as having a generally circular shape, the loop antenna 3500 need not be circular. For example, the loop antenna 350 can be configured to have an elliptical, square, rectangular, or any general-closed curve shape. It is understood that the antenna of an ear-worn or body-worn electronic device can be implemented as an unbalanced antenna or a balanced antenna.

The antennas 3300, 3400, 3500 shown in FIGS. 33-35 can be coupled to a matching network comprising an NFC of a type previously described. When energized, the NFC of the matching network operates to cancel out a positive sloped reactance over a wide band of frequencies (e.g., an 80 MHz bandwidth with f_{c}=2.44 GHz).

Although several of the embodiments illustrated in the Figures are directed to an ear-worn electronic hearing device, embodiments of the disclosure include any type of body-worn electronic device that incorporates a wireless communication device. Representative body-worn electronic devices include, but are not limited to, fitness and/or health monitoring watches or other wrist worn or hand-held objects, e.g., Apple Watch®, Fitbit®, cell phones, smartphones, handheld radios, medical implants, hearing aid accessories, wireless capable helmets (e.g., used in professional football), and wireless headsets/headphones (e.g., virtual reality headsets). Each of these devices is represented by the system block diagram of FIG. 7A or 7B, with the components of FIGS. 7A and 7B varying depending on the particular device implementation. Each of these devices can incorporate a matching network of a type illustrated in FIGS. 12A-30. Also, in any of the embodiments disclosed herein, one or more NFCs can be implemented to perform multi-reactive-element compensation of more complex antenna impedances (e.g., those show in FIGS. 3 and 4). These embodiments can be extended to a filter “impedance-inverter”, for example.

This document discloses numerous embodiments, including but not limited to the following:

Item 1 is an ear-worn electronic hearing device configured to be worn by a wearer, comprising:

a housing configured to be supported by, at, in or on an ear of the wearer;

electronic circuitry disposed in the housing and comprising a radio frequency transceiver;

a power source coupled to the electronic circuitry;

an antenna disposed in, on, or extending from the housing and operably coupled to the transceiver; and

a matching network operably coupled to the transceiver and the antenna, the matching network comprising a non-Foster active circuit coupled to the power source.

Item 2 is the hearing device of item 1, wherein the non-Foster active circuit is configured to provide a negative inductance or a negative capacitance.
Item 3 is the hearing device of item 1, wherein the non-Foster active circuit is configured to cause the matching network and the antenna to achieve a bandwidth beyond a Bode-Fano limit.
Item 4 is the hearing device of item 1, wherein the non-Foster active circuit is configured to cause the antenna to achieve a bandwidth of at least about 80 MHz.
Item 5 is the hearing device of item 1, wherein the non-Foster active circuit comprises at least one negative inductor and at least one capacitor.
Item 6 is the hearing device of item 1, wherein the non-Foster active circuit comprises at least one negative capacitor and at least one inductor.
Item 7 is the hearing device of item 1, wherein the non-Foster active circuit comprises at least one negative inductor and at least one negative capacitor.
Item 8 is the hearing device of item 1, wherein:

the matching network comprises an input coupled to the transceiver and an output coupled to the antenna; and

the non-Foster active circuit comprises a non-Foster active component coupled in series between the input and the output.

Item 9 is the hearing device of item 1, wherein:

the matching network comprises an input coupled to the transceiver and an output coupled to the antenna; and

the non-Foster active circuit comprises a non-Foster active component coupled in shunt between ground and a connection between the input and the output.

Item 10 is the hearing device of item 1, wherein the matching network comprises an input coupled to the transceiver and an output coupled to the antenna, and the non-Foster active circuit comprises:

a first component coupled in series between the input and the output; and

a second component coupled in shunt between ground and a connection between the input and the first component;

wherein one of the first and second components is a non-Foster active component and the other of the first and second components is a Foster component.

Item 11 is the hearing device of item 1, wherein the matching network comprises an input coupled to the transceiver and an output coupled to the antenna, and the non-Foster active circuit comprises:

a first component coupled in series between the input and the output; and

a second component coupled in shunt between ground and a connection between the input and the first component;

wherein the first and second components are non-Foster active components.

Item 12 is the hearing device of item 1, wherein the matching network comprises an input coupled to the transceiver and an output coupled to the antenna, and the non-Foster active circuit comprises:

a first component coupled in series between the input and the output; and

a second component coupled in shunt between ground and a connection between the first component and the output;

wherein one of the first and second components is a non-Foster active component and the other of the first and second components is a Foster component.

Item 13 is the hearing device of item 1, wherein the matching network comprises an input coupled to the transceiver and an output coupled to the antenna, and the non-Foster active circuit comprises:

a first component coupled in series between the input and the output; and

a second component coupled in shunt between ground and a connection between the first component and the output;

wherein the first and second components are non-Foster active components.

Item 14 is the hearing device of item 1, wherein the matching network comprises an input coupled to the transceiver and an output coupled to the antenna, and the non-Foster active circuit comprises:

a first component and a second component coupled in series between the input and the output;

wherein one of the first and second components is a non-Foster active component and the other of the first and second components is a Foster component.

Item 15 is the hearing device of item 1, wherein the matching network comprises an input coupled to the transceiver and an output coupled to the antenna, and the non-Foster active circuit comprises a negative inductor and a negative capacitor coupled in series between the input and the output.
Item 16 is the hearing device of item 1, wherein the matching network comprises an input coupled to the transceiver and an output coupled to the antenna, and the non-Foster active circuit comprises:

a first component coupled in shunt between ground and a first connection between the input and output; and

a second component coupled in shunt between ground and a second connection between the input and output;

wherein one of the first and second components is a non-Foster active component.

Item 17 is the hearing device of item 1, wherein the matching network comprises an input coupled to the transceiver and an output coupled to the antenna, and the non-Foster active circuit comprises:

a negative inductor coupled in shunt between ground and a first connection between the input and output; and

a negative capacitor coupled in shunt between ground and a second connection between the input and output.

Item 18 is an ear-worn electronic hearing device configured to be worn by a wearer, comprising:

a housing configured to be supported by, at, in or on an ear of the wearer;

electronic circuitry disposed in the housing and comprising a radio frequency transceiver;

a power source coupled to the electronic circuitry;

an antenna disposed in, on, or extending from the housing and operably coupled to the transceiver; and

a matching network operably coupled to the transceiver and the antenna, the matching network comprising a non-Foster active circuit coupled to the power source and configured to provide a negative inductance or a negative capacitance and to cause the antenna to achieve a bandwidth of at least about 80 MHz centered at about 2.44 GHz.

Item 19 is the hearing device of item 18, wherein the hearing device is a hearing aid.
Item 20 is a body-worn electronic device, comprising:

a housing configured to be held by, attached to or worn by a wearer;

electronic circuitry disposed in the housing and comprising a radio frequency transceiver;

a power source coupled to the electronic circuitry;

an antenna disposed in, on, or extending from the housing and operably coupled to the transceiver; and

a matching network operably coupled to the transceiver and the antenna, the matching network comprising a non-Foster active circuit coupled to the power source.

Item 21 is the device of item 20, wherein the non-Foster active circuit is configured to cause the antenna to achieve a bandwidth of about 80 MHz centered at about 2.44 GHz.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electromagnetic signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. An ear-worn electronic hearing device configured to be worn by a wearer, comprising:
a housing configured to be supported by, at, in or on an ear of the wearer;
electronic circuitry disposed in the housing and comprising a radio frequency transceiver;
a power source coupled to the electronic circuitry;
an antenna disposed in, on, or extending from the housing and operably coupled to the transceiver; and
a matching network operably coupled to the transceiver and the antenna, the matching network comprising a non-Foster active circuit coupled to the power source, wherein the non-Foster active circuit comprises one of:
at least one negative inductor and at least one capacitor;
at least one negative capacitor and at least one inductor; and
at least one negative inductor and at least one negative capacitor.

2. The hearing device of claim 1, wherein the non-Foster active circuit is configured to provide a negative inductance or a negative capacitance.

3. The hearing device of claim 1, wherein the non-Foster active circuit is configured to cause the matching network and the antenna to achieve a bandwidth beyond a Bode-Fano limit.

4. The hearing device of claim 1, wherein the non-Foster active circuit is configured to cause the antenna to achieve a bandwidth of at least about 80 MHz.

5-7. (canceled)

8. The hearing device of claim 1, wherein:
the matching network comprises an input coupled to the transceiver and an output coupled to the antenna; and
the non-Foster active circuit comprises a non-Foster active component coupled in series between the input and the output.

9. The hearing device of claim 1, wherein:
the matching network comprises an input coupled to the transceiver and an output coupled to the antenna; and
the non-Foster active circuit comprises a non-Foster active component coupled in shunt between ground and a connection between the input and the output.

10. The hearing device of claim 1, wherein the matching network comprises an input coupled to the transceiver and an output coupled to the antenna, and the non-Foster active circuit comprises:
a first component coupled in series between the input and the output; and
a second component coupled in shunt between ground and a connection between the input and the first component;
wherein one of the first and second components is a non-Foster active component and the other of the first and second components is a Foster component.

11. The hearing device of claim 1, wherein the matching network comprises an input coupled to the transceiver and an output coupled to the antenna, and the non-Foster active circuit comprises:
a first component coupled in series between the input and the output; and
a second component coupled in shunt between ground and a connection between the input and the first component;
wherein the first and second components are non-Foster active components.

12. The hearing device of claim 1, wherein the matching network comprises an input coupled to the transceiver and an output coupled to the antenna, and the non-Foster active circuit comprises:
a first component coupled in series between the input and the output; and
a second component coupled in shunt between ground and a connection between the first component and the output;
wherein one of the first and second components is a non-Foster active component and the other of the first and second components is a Foster component.

13. The hearing device of claim 1, wherein the matching network comprises an input coupled to the transceiver and an output coupled to the antenna, and the non-Foster active circuit comprises:
a first component coupled in series between the input and the output; and
a second component coupled in shunt between ground and a connection between the first component and the output;
wherein the first and second components are non-Foster active components.

14. The hearing device of claim 1, wherein the matching network comprises an input coupled to the transceiver and an output coupled to the antenna, and the non-Foster active circuit comprises:
a first component and a second component coupled in series between the input and the output;
wherein one of the first and second components is a non-Foster active component and the other of the first and second components is a Foster component.

15. The hearing device of claim 1, wherein the matching network comprises an input coupled to the transceiver and an output coupled to the antenna, and the non-Foster active circuit comprises a negative inductor and a negative capacitor coupled in series between the input and the output.

16. The hearing device of claim 1, wherein the matching network comprises an input coupled to the transceiver and an output coupled to the antenna, and the non-Foster active circuit comprises:
a first component coupled in shunt between ground and a first connection between the input and output; and
a second component coupled in shunt between ground and a second connection between the input and output;
wherein one of the first and second components is a non-Foster active component.

17. The hearing device of claim 1, wherein the matching network comprises an input coupled to the transceiver and an output coupled to the antenna, and the non-Foster active circuit comprises:
a negative inductor coupled in shunt between ground and a first connection between the input and output; and
a negative capacitor coupled in shunt between ground and a second connection between the input and output.

18. An ear-worn electronic hearing device configured to be worn by a wearer, comprising:
a housing configured to be supported by, at, in or on an ear of the wearer;
electronic circuitry disposed in the housing and comprising a radio frequency transceiver;
a power source coupled to the electronic circuitry;
an antenna disposed in, on, or extending from the housing and operably coupled to the transceiver; and
a matching network operably coupled to the transceiver and the antenna, the matching network comprising a non-Foster active circuit coupled to the power source and configured to provide a negative inductance or a negative capacitance and to cause the antenna to achieve a bandwidth of at least about 80 MHz centered at about 2.44 GHz, wherein the non-Foster active circuit comprises one of:
at least one negative inductor and at least one capacitor;
at least one negative capacitor and at least one inductor; and
at least one negative inductor and at least one negative capacitor.

19. The hearing device of claim 18, wherein the hearing device is a hearing aid.

20. A body-worn electronic device, comprising:
a housing configured to be held by, attached to or worn by a wearer;
electronic circuitry disposed in the housing and comprising a radio frequency transceiver;
a power source coupled to the electronic circuitry;
an antenna disposed in, on, or extending from the housing and operably coupled to the transceiver; and
a matching network operably coupled to the transceiver and the antenna, the matching network comprising a non-Foster active circuit coupled to the power source, wherein the non-Foster active circuit comprises one of:
at least one negative inductor and at least one capacitor;
at least one negative capacitor and at least one inductor; and
at least one negative inductor and at least one negative capacitor.

21. The device of claim 20, wherein the non-Foster active circuit is configured to cause the antenna to achieve a bandwidth of about 80 MHz centered at about 2.44 GHz.
